(19) United States
(12) Patent Application Publication
(10) Pub. No.: US 2008/0223238 A1
(43) Pub. Date: Sep. 18, 2008

(54) Systems and Methods for Reducing Output Delays Associated With Ink Drying

(75) Inventors: David E. DeBellis, Vancouver, WA (US); David E. Smith, Vancouver, WA (US); Kenneth B. Wade, Battle Ground, WA (US); Edward L. Feldhousen, Portland, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, LP, Fort Collins, CO (US)

(21) Appl. No.: 11/686,566

(22) Filed: Mar. 15, 2007

(51) Int. Cl. B41F 23/04

(52) U.S. Cl. 101/424.1

(57) ABSTRACT

In one embodiment, a system and a method pertain to calculating a number of dryer passes that will be used to dry ink applied to print media, the number of dryer passes being calculated relative to a current dryer temperature, applying ink to the print media, and drying the applied ink with the dryer using the calculated number of dryer passes without first waiting for the dryer to reach its normal operating temperature.

### BACKGROUND

Ink-based printing devices often include a dryer that is used to speed drying of ink that has been deposited on print media before the media is output from the printing device. Such dryers typically must warm up before they are used, particularly if printing has not recently been performed.

Given that it can take a significant amount of time for the dryer to warm up, for example between 30 and 60 seconds, dryer warm-up can significantly delay the output of printed media from the printing device. Although the dryer could be continuously powered to render warm-up unnecessary, it is impractical to do so because most dryers consume relatively large amounts of energy when maintained at normal operating temperature. Furthermore, although the dryer could be overdriven with significantly more power in an effort to accelerate warm-up, such a practice may affect the reliability of the printing device and its internal components.

### BRIEF DESCRIPTION OF THE DRAWINGS

The disclosed systems and methods can be better understood with reference to the following drawings. The components in the drawings are not necessarily to scale.

FIG. 1 is a perspective view of an embodiment of a printing device configured to reduce delays in the output of printed sheets.

FIG. 2 is a block diagram of an embodiment of the printing device of FIG. 1.

FIG. 3 is schematic view of an embodiment of a print mechanism of the printing device of FIG. 1.

FIG. 4 is a flow diagram of an embodiment of a method for reducing delay in the output of printed sheets from a printing device.

FIG. 5 is a flow diagram of an embodiment of a method for calculating a number of dryer passes to be used to dry ink provided on print media.

### DETAILED DESCRIPTION

As described above, dryer warm-up can significantly delay the output of printed media from a printing device. As described in the following, however, such output delays can be reduced or eliminated by using the dryer to dry the ink on the media before the dryer has reached its normal operating temperature. In such a case, the drying can be achieved without having to wait for the dryer to warm up. The number of times the media is to pass by or through the dryer may be increased due at least in part to the relatively low dryer temperature. That number of dryer passes is determined by the printing device relative to various factors. In at least some embodiments, those factors include the nature of the print data and the current dryer temperature. In other embodiments, the factors that are considered further include current environment conditions and the type of media to which the ink will be applied.

Disclosed herein are embodiments of systems and methods for reducing output delays associated with ink drying. More particularly, disclosed are embodiments of systems and methods for reducing output delays caused by dryer warm-up. Although particular embodiments are disclosed, those embodiments are provided for purposes of example only to facilitate description of the disclosed systems and methods. Therefore, the disclosed embodiments are not intended to limit the scope of this disclosure.

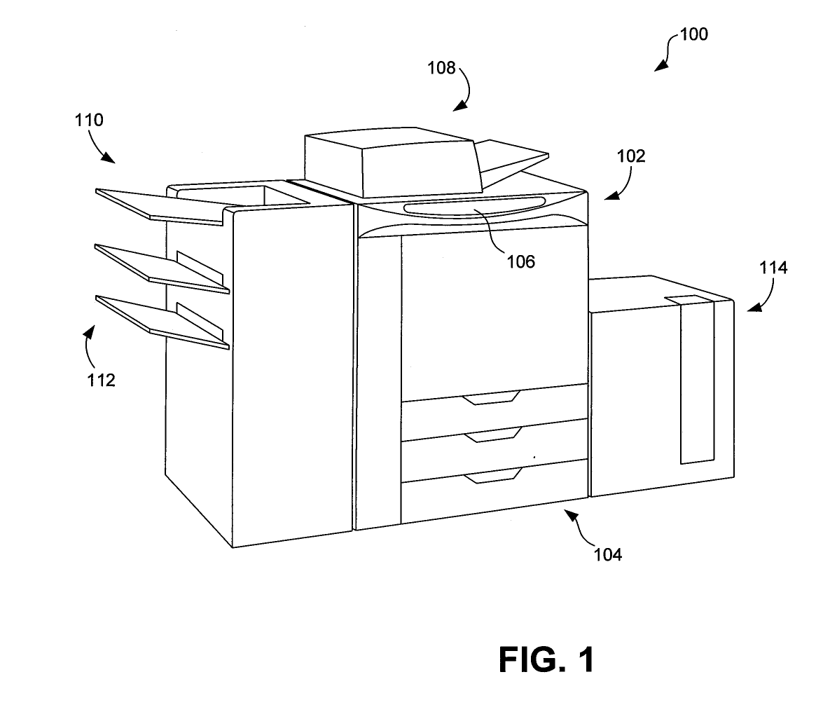

Referring now in more detail to the drawings, in which like numerals indicate corresponding parts throughout the several views, FIG. 1 illustrates an embodiment of a printing device 100. By way of example, the printing device 100 comprises an inkjet printer. Although a “printer” has been specifically mentioned, it is noted that the printing device 100 need not be limited to printing functionality alone. For example, in some embodiments, the printing device 100 can provide further functionalities such as copying, faxing, and emailing. In such a case, the printing device 100 may be described as a multi-functional printing device.

As indicated in FIG. 1, the printing device 100 comprises a main printing unit 102 that contains the various internal components of the print mechanism. As described below, those components can comprise one or more inkjet pens configured to eject droplets of ink on a suitable print medium, such as paper. As further indicated in FIG. 1, the main printing unit 102 includes one or more media input trays 104 in which sheets of print media can be loaded. In addition, the printing unit 102 comprises a control panel 106 with which a user can interface to enter various selections that control operation of the printing device 100. Optionally, the print unit 102 further comprises an automatic document feeder 108 with which sheets of media can be automatically positioned on a platen (not shown) of the printing device 100 to enable copying of images provided on that media.

In the embodiment of FIG. 1, the printing device 100 further includes a media output device 110 that comprises one or more media output trays 112 in which printed media can be output from the printing device. In addition, the printing device 100 of FIG. 1 includes a high-capacity media input device 114 that, like the media trays 104, can store media to be input into a media path of the printing device.

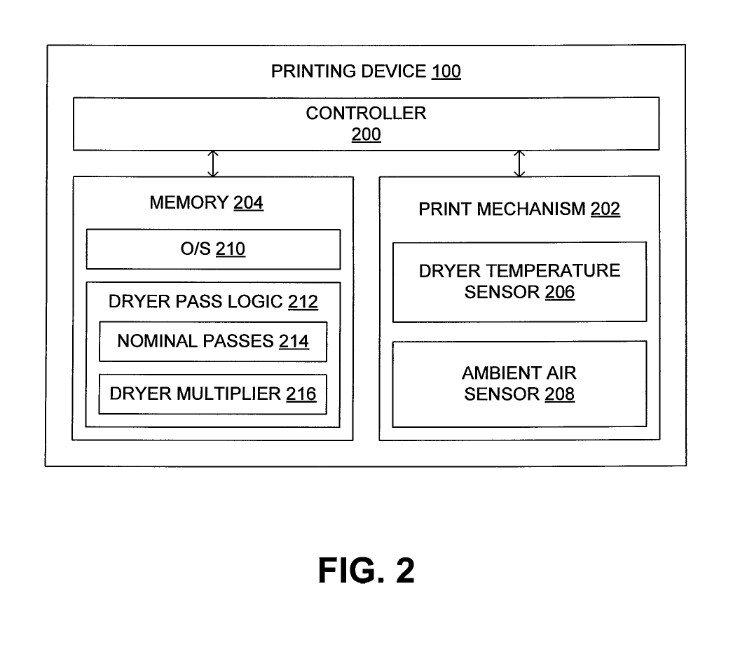

FIG. 2 is a block diagram illustrating an example architecture for the printing device 100 of FIG. 1. As is indicated in FIG. 2, the printing device 100 comprises a controller 200, a print mechanism 202, and memory 204. The controller 200 is adapted to execute commands that control operation of the printing device 100 and can, for example, comprise one or more processors and/or application-specific integrated circuits (ASICs).

As described above, the print mechanism 202 includes various components that are used to perform printing, including, for example, drive motors and associated transmissions, drive rollers, a print surface, inkjet pens, and an ink dryer. As shown in FIG. 2, the print mechanism 202 further includes a dryer temperature sensor 206 and an ambient air sensor 208. In some embodiments, the dryer temperature sensor 206 comprises a thermistor provided within the dryer. In some embodiments, the ambient air sensor 208 comprises a temperature sensor and a relative humidity sensor that is/are positioned on the interior or exterior of the printing device 100.

The memory 204 comprises any one or a combination of volatile memory elements (e.g., random access memory (RAM)) and nonvolatile memory elements (e.g., read-only memory (ROM), Flash memory, hard disk, etc.). The memory 204 stores various programs and other logic including an operating system (O/S) 210 that comprises the commands used to control general operation of the printing device 100. In addition, the memory 204 stores dryer pass logic 212 that is used to determine the number of times printed media is to pass by or through the dryer (i.e., dryer passes). In at least some embodiments, the dryer pass logic 212 determines the number of dryer passes relative to information collected from one or both of the dryer temperature sensor 206 and the ambient air sensor 208.

As is further illustrated in FIG. 2, the dryer pass logic 212 can comprise nominal passes logic 214 that is used to determine the nominal number of dryer passes that would be required to adequately dry printed media under normal operating conditions, and dryer multiplier logic 216 that is used to determine a dryer multiplier that is to be applied to the nominal number of dryer passes to take into account conditions that may adversely affect drying capability, including relatively low dryer temperatures.

Various programs (logic) have been described herein. Those programs can be stored on any computer-readable medium for use by or in connection with any computer-related system or method. In the context of this document, a “computer-readable medium” is an electronic, magnetic, optical, or other physical device or means that contains or stores a computer program for use by or in connection with a computer-related system or method. Those programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

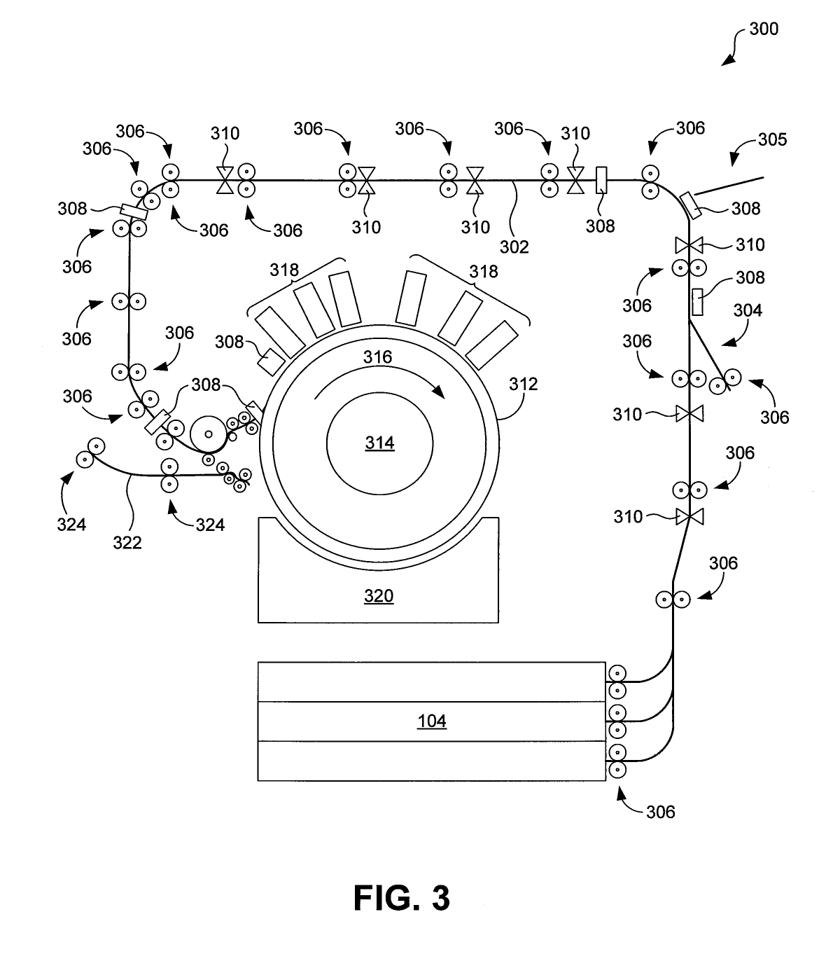

FIG. 3 schematically illustrates an example print mechanism 300 for the printing device 100 of FIG. 1. The print mechanism 300 comprises a media path along which media traverses within the printing device 100. Included in the media path is a print path 302 along which media traverses to reach a print surface described below. In some cases, media can be input into the print path 302 from the input trays 104 first described in relation to FIG. 1. In other cases, media can be input into the print path 302 at a high-capacity input area 304 associated with the high-capacity input tray 114 also shown in FIG. 1. In still other cases, media can be input into the print path 302 at a bypass input area 305 associated with a bypass tray of the printing device 100 (not shown).

Irrespective of how media is input into the print path 302, the media is driven along the path by a plurality of drive rollers 306, which are driven by motors and associated transmissions (not shown) of the print mechanism 100. Positioned at various locations along the print path 302 are sensors that detect the presence, or absence, of media. For example, various optical sensors 308 are provided as are various mechanical sensors 310.

During operation, sheets of print media are driven along the print path 302 toward a print surface 312. In the embodiment of FIG. 3, the print surface 312 is the outer surface of a metal print drum 314 that is rotated by an associated drive motor and transmission (not shown) in the direction indicated by arrow 316. The print surface 312 of the drum 314 can be divided into multiple drum zones with which the sheets of media can be coordinated. Specifically, the leading edges of the media sheets can be aligned with the leading edges of particular drum zones during printing to precisely align the media with media hold-down features of the drum 314 as well as to enable removal of the media from the drum after printing has been completed. In some embodiments, the hold-down features include perforations that are used to apply a vacuum to the media to hold the media in place on the print surface 312.

Once the print media reaches the drum 314, the media is loaded on the print surface 312 in alignment with a given drum zone. The media then rotates with the drum 314 in the direction of arrow 316 so that the media passes under inkjet pens 318 that are used to eject droplets of ink onto the media. That ink is dried on the media using an ink dryer 320 that comprises one or more internal heating elements and one or more fans (not shown) that blow hot air over the media as it passes the dryer on the drum 314. After printing and drying have been completed, the media is removed from the drum 314 and is output from the printing device 100 along an output path 322 that comprises its own drive rollers 324.

Example systems having been described above, operation of the systems will now be discussed. In the discussions that follow, flow diagrams are provided. Process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

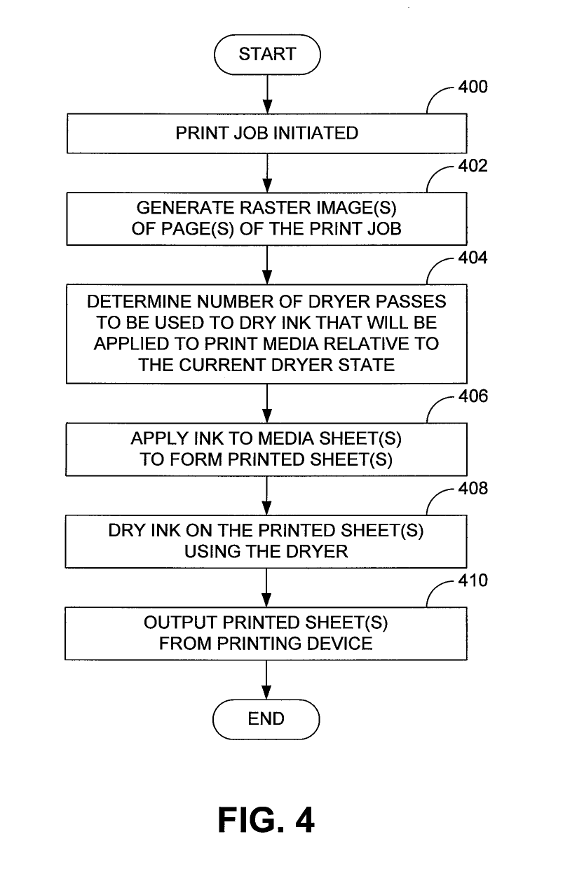

FIG. 4 illustrates an example method for reducing delay in the output of printed sheets associated with ink drying and, more particularly, with dryer warm-up. In the method of FIG. 4, a print job is first initiated on the printing device (block 400) and one or more raster images are generated for the various pages of the job (block 402). With reference next to block 404,the printing device calculates a number of dryer passes to be used to dry ink that will be applied to print media relative to the current state of the dryer. Notably, if the dryer is below the normal operating temperature, a greater number of dryer passes may be required to obtain adequate drying.

As described in greater detail below, the number of dryer passes to be used in block 404 can be determined relative to various factors, including current dryer temperature and the nature of the data that is to be printed on the media. Other factors can also be taken into account, such as current environmental conditions and the nature of the media. In at least some embodiments, the number of dryer passes is obtained by determining a nominal number of passes that would be used if the dryer were at normal operating temperature, and determining a dryer multiplier that can be used to adjust (e.g., increase) the nominal number of dryer passes to account for various considered factors. By way of example, the nominal number of passes is determined relative to one or more of the print content, the type of print media being used, and the selected print mode. Also by way of example, the dryer multiplier is determined relative to one or both of the dryer temperature and current environmental conditions.

Turning to block 406, ink is applied to one or more media sheets to form one or more printed sheets. By way of example, the ink is ejected from inkjet pens of the printing device. After the ink has been applied, the ink is dried on the printed sheets using the dryer, as indicated in block 408. More particularly, the ink on the printed sheets is dried using the number of dryer passes calculated in block 404.

Once the ink has been dried to a desired degree using the relevant number of dryer passes, the one or more printed sheets are output from the printing device, as indicated in block 410.

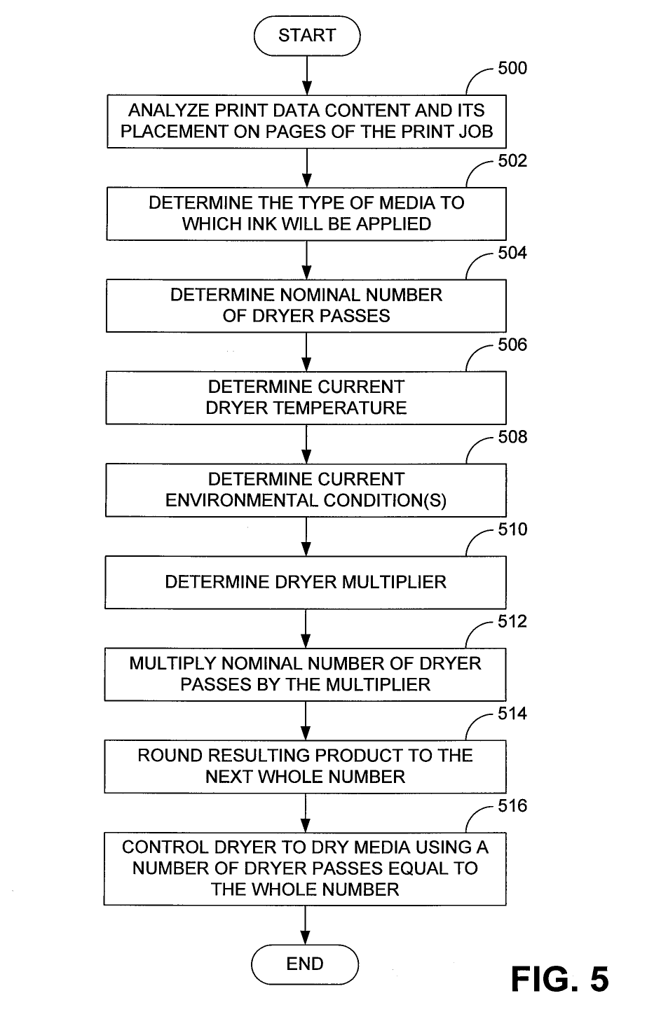

FIG. 5 illustrates an example method for calculating a number of dryer passes in cases that can be used to obtain acceptable ink drying from the dryer even when it is not at normal operating temperature, thereby reducing delays that would normally due to dryer warm-up. Beginning with block 500, dryer pass logic, (e.g., logic 212 of FIG. 2) of the printing device analyzes the content of the print data of a received print job and identifies the placement of that content on the pages of the print job. Through such analysis, the ink density of multiple segments or regions of those pages can be identified. Ink density is relevant given that pages having relatively high ink density may require more dryer passes than pages having relatively low ink density. Furthermore, the print data analysis may reveal other conditions that can affect dry time, such as the print mode (e.g., simplex versus duplex) that has been selected from the print job.

The dryer pass logic also determines the type of media to which the ink will be applied, as indicated in block 502, given that some types of media will absorb ink more quickly than other types of media. Understandably, media that absorbs ink more slowly may require more dryer passes than media that absorbs ink more quickly. In some embodiments, the dryer pass logic determines the media type from media type selections or identifications provided by the user. In other embodiments, the dryer pass logic determines the media type using one or more detectors provided within the printing device that detect physical attributes of the media. In determining the media type, the dryer pass logic identifies one or more of the material from which the media is constructed, the surface characteristics of the media (e.g., glossy or flat), and the thickness of the media.

With knowledge of the print data and the print media, the dryer pass logic, and more particularly the nominal passes logic (e.g., nominal passes logic 214 of FIG. 2), determines the nominal number of dryer passes (block 504), i.e., the number of dryer passes that would be deemed appropriate if the dryer were at its normal operating temperature. In some embodiments, the nominal passes logic calculates the nominal number of dryer passes using an algorithm formulated with reference to empirical ink drying data. In other embodiments, the nominal passes logic calculates the nominal number of dryer passes using a look-up table constructed with reference to such empirical data.

Next, with reference to block 506, the dryer pass logic identifies the current temperature of the dryer given that a greater number of dryer passes may be required for relatively low dryer temperatures. By way of example, the dryer pass logic determines the current dryer temperature using the dryer temperature sensor of the printing device. In addition, the dryer pass logic determines the current environmental conditions in which the printing device is used, as indicated in block 508. Such conditions can comprise one or both of ambient temperature and relative humidity.

With knowledge of the dryer temperature and the environmental conditions, the dryer pass logic, and more particularly the dryer multiplier logic (e.g., dryer multiplier logic 216 of FIG. 2), determines a dryer multiplier (block 510) that will be applied to the nominal number of dryer passes to potentially increase the number of dryer passes that will be used to dry ink on the printed media. In some embodiments, the dryer multiplier logic calculates the multiplier using an algorithm formulated with reference to empirical ink drying data. In other embodiments, the dryer multiplier logic calculates the multiplier using a look-up table constructed with reference to such empirical data. Regardless, the multiplier normally is a value that is greater than one.

Once the multiplier has been determined, the dryer pass logic multiplies the nominal number of dryer passes by the multiplier, as indicated in block 512. Therefore, if the nominal number of dryer passes was determined to be 2.4 passes, and the multiplier was determined to be 1.5, the resulting product is 3.6. Next, as indicated in block 514, the dryer pass logic rounds the resulting product from block 512 up to the next whole number. Therefore, if the resulting product was 3.6 as in the previous example, the next whole number is 4. Finally, the dryer pass logic controls the dryer to dry ink on the printed media using a number of dryer passes equal to the whole number, as indicated in block 516. In keeping with the previous example, the media would be dried using 4 dryer passes.

As is apparent from the foregoing, faster output can be obtained through use of the disclosed systems and methods given that a printed sheet can be immediately dried using the printing device dryer without having to wait for the dryer to warm up. Even though a greater number of dryer passes may be necessary to dry the ink applied to the media, shorter overall delays typically will be observed. The functionality described in the foregoing may be particularly useful in situations in which the printing device has been in a low power mode for an extended period of time. Moreover, such functionality may be particularly useful in situations in which the printing device is having difficulty in warming the dryer to its normal operating temperature, for example if the requisite level of energy is unavailable to fully power the dryer. Therefore, systems and methods described above can preserve the responsiveness of the printing device in as many conditions as possible.

It is noted that application of the dryer multiplier may not always result in a greater number of dryer passes. In particular, when the nominal number of passes is less than one, the calculated number of passes may still be less than one even when the multiplier is greater than one. For example, if the nominal number of passes is determined to be 0.4 and the multiplier is determined to be 1.5, the resulting integer is 0.8, and only one dryer pass will be used to dry the media. Moreover, it is noted that the multiplier need not be applied only in cases in which the dryer is below its normal operating temperature. Instead, the multiplier can be applied every time printing is performed. In cases in which the dryer is at its normal operating temperature, the multiplier may be relatively low or may even be 1.0, thereby having little to no effect on the number of dryer passes. However, additional dryer passes can be used even when the dryer is at or near operating temperature if other conditions, such as environmental conditions, are such that additional passes would be beneficial.

1. A method for reducing delays in output from a printing device, the method comprising:
receiving a print job with a printing device that comprises an ink dryer that currently is not at normal operating temperature;
calculating a number of dryer passes that will be used to dry ink applied to print media, the number of dryer passes being calculated relative to current dryer temperature;
applying ink to the print media; and
drying the applied ink with the dryer using the calculated number of dryer passes without first waiting for the dryer to reach its normal operating temperature.

2. The method of claim 1, wherein calculating a number of dryer passes comprises determining a nominal number of dryer passes that would be used if the dryer were at normal operating temperature.

3. The method of claim 2, wherein determining a nominal number of dryer passes comprises analyzing the print job content.

4. The method of claim 2, wherein determining a nominal number of dryer passes comprises determining the print media type.

5. The method of claim 2, wherein calculating a number of dryer passes further comprises determining a dryer multiplier that can be used to adjust the nominal number of dryer passes to account for the current dryer temperature.

6. The method of claim 5, wherein determining a dryer multiplier comprises determining the current dryer temperature.

7. The method of claim 5, wherein determining a dryer multiplier comprises determining current environmental conditions.

8. A method for calculating a number of dryer passes to be used to dry ink applied to print media within a printing device, the method comprising:
determining a nominal number of dryer passes that would be used if a dryer of the printing device were at normal operating temperature;
determining a dryer multiplier that can be used to adjust the nominal number of dryer passes to account for a current dryer state; and
multiplying the nominal number of dryer passes by the dryer multiplier to obtain the number of dryer passes to be used.

9. The method of claim 8, determining a nominal number of dryer passes comprises analyzing print data content and determining ink density from that analysis.

10. The method of claim 8, wherein determining a nominal number of dryer passes comprises determining print media type.

11. The method of claim 8, wherein determining a dryer multiplier comprises determining current dryer temperature.

12. The method of claim 8, wherein determining a dryer multiplier comprises determining current environmental conditions.

13. A system for calculating a number of dryer passes to be used, the system comprising:
means for determining a nominal number of dryer passes;
means for determining a dryer multiplier that can be used to adjust the nominal number of dryer passes to account for current observed conditions; and
means for multiplying the nominal number of dryer passes by the dryer multiplier to obtain the number of dryer passes to be used.

14. The system of claim 13, wherein the means for determining a nominal number of dryer passes comprise means for analyzing print data content to determine ink density.

15. The system of claim 13, wherein the means for determining a nominal number of dryer passes comprises means for determining print media type.

16. The system of claim 13, wherein the means for determining a dryer multiplier comprise a temperature sensor used to measure dryer temperature.

17. The system of claim 13, wherein the means for determining a dryer multiplier comprise a sensor used to measure ambient temperature and relative humidity.

18. A printing device comprising:
a controller;
a print mechanism including an ink dryer; and
memory that stores dryer pass logic configured to calculate a number of dryer passes that will be used to dry ink applied to print media, the number of dryer passes being calculated relative to current dryer temperature such that applied ink can be dried using the dryer without waiting for the dryer to reach its normal operating temperature.

19. The printing device of claim 18, wherein the dryer pass logic is configured to determine a nominal number of dryer passes that would be used if the dryer were at normal operating temperature and determine a dryer multiplier that can be used to adjust the nominal number of dryer passes to account for conditions that may adversely affect the ability of the dryer to dry the ink.

20. The printing device of claim 19, wherein the dryer pass logic determines the nominal number of dryer passes by analyzing print data content.

21. The printing device of claim 19, wherein the dryer pass logic determines the nominal number of dryer passes by determining print media type.

22. The printing device of claim 19, wherein the dryer pass logic determines the dryer multiplier by determining current dryer temperature.

23. The printing device of claim 19, wherein the dryer pass logic determines the dryer multiplier by determining current environmental conditions.
